(19) United States
(12) Patent Application Publication
(10) Pub. No.: US 2003/0089854 A1
(43) Pub. Date: May 15, 2003

(54) Apparatus and method for remotely sensing hydrocarbons and other pollutants in vehicle emissions

(76) Inventors: Peter S. Shifflett, Tucson, AZ (US); James H. Johnson, Tucson, AZ (US); Jason K. Webster, Tucson, AZ (US)

Correspondence Address: Deborah b. Blyveis, Birdwell Janke & Durando, PLC, 1100 SW Sixth Avenue, Suite 1400, Portland, OR, 97204, US

(21) Appl. No.: 10/039,431

(22) Filed: Nov. 9, 2001

(51) Int. Cl. G01N 21/35; G01N 21/33

(52) U.S. Cl. 250/339.05; 250/372

(57) ABSTRACT

An apparatus and method for measuring pollutants in a vehicle exhaust by remotely sensing hydrocarbons and nitric oxide using ultraviolet light, and measuring carbon dioxide and other pollutants using infrared light. A collimated beam of ultraviolet and a near-infrared light is propagated across the road through the exhaust plume of a vehicle. After the light beam has passed through the exhaust, a retroreflector reflects the light beam back. A beam splitter passes the infrared light to an infrared detector and deflects the ultraviolet light to an ultraviolet spectrometer. The ultraviolet spectrometer produces ultraviolet signals representative of the amount of hydrocarbons and nitric oxide in the vehicle exhaust. The infrared detector produces an infrared signal representative of the amount of carbon dioxide and other pollutants in the exhaust plume. The spectrometer and detector send the respective signals to a processor for calculation of the amounts of pollutants in the exhaust. A camera is used to take a picture of the license plate of a vehicle that emits too many pollutants.

### FIELD OF THE INVENTION

This invention relates to systems for using optical spectroscopy to detect pollutants in a gas, and particularly to an apparatus and method for remotely detecting the amount of hydrocarbons and other pollutants in the exhaust plume of a vehicle.

### BACKGROUND OF THE INVENTION

Motor vehicle exhaust is of great concern to the public because it is a major cause of atmospheric pollution in many areas of the country. Although there are government emission standards for the maximum amount of pollutants allowed in the vehicle exhaust, there are numerous vehicles whose exhaust exceeds this maximum. A vehicle's emissions can function improperly without the owner's knowledge. In addition, an owner can inadvertently or purposefully make changes to the vehicle that increase emissions. It is therefore necessary to be able to remotely test a vehicle's exhaust to determine if the exhaust exceeds the government emission standards.

Various methods are known for testing the emissions from a vehicle. According to one method, infrared and ultraviolet light sources are directed through a plume of vehicle exhaust. Certain pollutants in the exhaust are known to absorb specific wavelengths of light. After the infrared and ultraviolet light passes through the plume of vehicle exhaust, the decrease in the intensities of the wavelengths of light corresponding to the various pollutants is measured. The amount of pollutants in the exhaust is calculated from the decrease in intensity of the light that corresponds to a particular pollutant.

U.S. Pat. No. 5,210,702 employs a broadband infrared source that passes through the exhaust of a vehicle in order to measure the amount of hydrocarbons, water, carbon monoxide and carbon dioxide in the exhaust of a vehicle driving on the road. It also includes a broadband ultraviolet light source that passes through the exhaust of a vehicle in order to measure the amount of nitrogen oxides in the exhaust. After the infrared and ultraviolet light beams have passed through the exhaust of a vehicle, a beam splitter splits the light and directs it to the respective detectors that measure the amount of hydrocarbons, water, carbon dioxide, carbon monoxide, and nitrogen oxides in the exhaust.

U.S. Pat. No. 5,726,450 employs a console that emits a broadband infrared source through a plume of smoke from a vehicle that has passed on the road. A reflector reflects the infrared light back to the console where it passes through a plurality of filters which filter out the wavelength of light that corresponds to a desired pollutant to be tested. A plurality of detectors determine the amount of pollutants such as carbon monoxide, carbon dioxide, hydrocarbons, water, and nitrous oxides.

U.S. Pat. No. 5,281,816 employs infrared and ultraviolet light that is passed through a gas that is contained in a test chamber to determine whether the gas is present in concentrations that could possibly be flammable or explosive. Ultraviolet light is used to determine the amount of hydrocarbon gas.

U.S. Pat. No. 5,621,166 employs a tunable diode laser to emit near to mid-infrared light through vehicle emissions at a sequence of wavelengths that correspond to the amount of water, carbon dioxide and carbon monoxide in the vehicle exhaust.

A disadvantage of using mid-infrared light to measure the amount of hydrocarbons in the vehicle exhaust is that water tends to absorb the mid-infrared light at the same wavelength as the hydrocarbons, thus interfering with an accurate calculation of hydrocarbon levels in the exhaust. A tunable laser diode that emits near-infrared light can be used to measure certain hydrocarbons, but these hydrocarbons are not associated with vehicle exhaust.

In contrast to hydrocarbons, it is advantageous to use near-infrared light to measure the amount of carbon monoxide and carbon dioxide in the vehicle exhaust. There are numerous absorption lines for water, and when using mid-infrared light the absorption lines for water are so close to the absorption lines for carbon dioxide and carbon monoxide it is hard to distinguish them. A more accurate reading is obtained when measuring carbon monoxide and carbon dioxide in the near-infrared range as opposed to the mid-infrared range. In the near-infrared range it is possible to use a tunable diode laser that can produce a bandwidth of infrared light that is very narrow, thus making it easier to pick out the absorption lines for carbon monoxide and carbon dioxide. In addition, the absorption of mid-infrared light by carbon dioxide is greater than the absorption of near-infrared light by those compounds. As a result, it is difficult to do remote testing from more than about thirty feet away using mid-infrared light because there is so much absorption that only a faint signal is produced.

Consequently, there is a need for an improved apparatus and method for remotely detecting hydrocarbons, in addition to other pollutants, in the exhaust of a vehicle in which water does not interfere with an accurate calculation of the levels of hydrocarbons in the exhaust. In addition, there is a need to provide an apparatus that accurately detects the amount of pollutants in the exhaust of a vehicle while reducing costs by limiting the quantity of light sources used in the apparatus.

### SUMMARY OF THE INVENTION

The aforementioned need has been met in the present invention by providing an improved apparatus and method for detecting pollutants in a vehicle exhaust by remotely detecting hydrocarbons using ultraviolet light, and detecting other pollutants using infrared light. A beam of ultraviolet light and a beam of infrared light are propagated across the road through the exhaust plume of a vehicle. A lens collimates the beams of light before they are propagated through the exhaust. After the light beams have passed through the exhaust, a retroreflector reflects the light beams back. Next, a beam splitter passes the infrared beam to an infrared detector and reflects the ultraviolet beam to an ultraviolet detector. The ultraviolet detector produces ultraviolet signals representative of the amount of hydrocarbons and nitric oxide in the vehicle exhaust. The infrared detector produces an infrared signal representative of the amount of various other pollutants in the exhaust plume such as carbon dioxide and carbon monoxide. The detectors send the respective signals to a processor for calculations of the amounts of pollutants in the exhaust. A camera is used to take a picture of the license plate of a vehicle that emits too many pollutants. In order to determine when a vehicle has passed on the road, a detector indicates the interruption by the vehicle of a light beam that is propagating across the road. Instead of having a separate light source and detector, the measurement infrared light source and the infrared detector can be used to detect a vehicle.

Accordingly, it is a principal object of the present invention to provide a novel and improved method and apparatus for remotely sensing the amount of pollutants in a vehicle exhaust.

It is another object of the invention to provide a method and apparatus for remotely sensing the amount of hydrocarbons and other pollutants in the vehicle exhaust without having the absorption of light by water interfere with the measurement.

It is a further object of the invention to provide an apparatus for accurately measuring the amount of pollutants in a vehicle exhaust by remote sensing while minimizing the number of light sources utilized.

The foregoing and other objects, features, and advantages of the invention will be more readily understood upon consideration of the following detailed description of the invention, taken in conjunction with the accompanying drawings.

### BRIEF DESCRIPTION OF THE DRAWINGS

FIG. 1 is a schematic optical pathway diagram of a remote sensing apparatus used to measure the amount of pollutants in a vehicle's exhaust according to the present invention.

FIG. 2 is a block diagram of the remote sensing apparatus of FIG. 1 that illustrates the use of a camera and a detector bar according to the present invention.

FIG. 3 is a schematic diagram of the contents of a telescope shown in FIG. 2.

FIG. 4 is a graph that depicts the absorption of light by various pollutants at predetermined wavelengths according to the present invention.

### DETAILED DESCRIPTION OF THE INVENTION

It has been discovered that useful absorption lines exist in the ultraviolet light spectrum for detecting the presence of hydrocarbons by remote sensing. The present invention takes advantage of that discovery to provide sensing of carbon dioxide, carbon monoxide, nitric oxide and hydrocarbons using only light in the near-infrared and ultraviolet spectra.

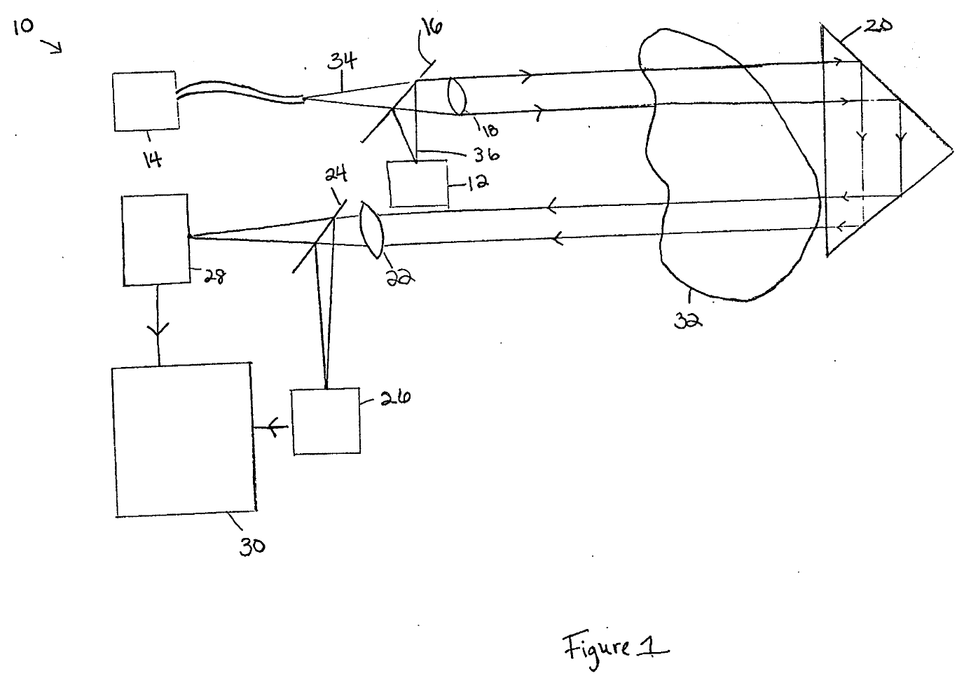

A remote sensing apparatus that measures hydrocarbons and other pollutants in a vehicle's exhaust according to the present invention is shown in FIGS. 1, 2 and 3. Referring to FIG. 1, the sensing apparatus 10 comprises an ultraviolet light source 12, an infrared light source 14, an output beam splitter 16, an output lens 18, a retroreflector 20, an input lens 22, an input beam splitter 24, an ultraviolet spectrometer 26, an infrared detector 28, and a processor 30. The infrared light source is preferably a variable wavelength tunable laser diode source such as a Model Lasir manufactured by Unisearch Associates, Inc. of Concord, Ontario, Canada. Preferably the spectrometer is a commercially available, broadband spectrometer that produces an output that is a function of wavelength, such as the Model S2000 manufactured by Ocean Optics, Inc. of Dunedin, Fla.

When a vehicle passes on the roadway it emits a plume of vehicle exhaust 32. The infrared light source 14 emits a variable-wavelength beam of near-infrared light 34 in the direction of the plume of vehicle exhaust 32. In addition, the ultraviolet light source 12 emits a broadband beam of ultraviolet light 36 in a direction perpendicular to the beam of infrared light 34. The first beam splitter 16 sits in the pathway of the beams of infrared 34 and ultraviolet 36 light, and passes the beam of infrared light 34 while reflecting the beam of ultraviolet light 36 toward the exhaust plum 32.

As the beam of ultraviolet light 36 passes through the exhaust plume 32, the hydrocarbons and nitric oxide in the exhaust absorb predetermined wavelengths of ultraviolet light. Similarly, as the beam of infrared light 34 passes through the exhaust plume 32, the carbon dioxide and carbon monoxide absorb predetermined wavelengths of infrared light. After the beams of ultraviolet 36 and infrared 34 light pass through the exhaust plume 32, the retroreflector 20 reflects the light beams 34 and 36 back through the exhaust plume 32. However, it is not necessary that the light beams pass through the exhaust plume 32 twice, and it can pass through only once without departing from the principles of the invention.

After the infrared 34 and ultraviolet 36 light beams are returned by the retroreflector 20, they are focused to a point by the input lens 22. The beams of infrared 34 and ultraviolet 36 light encounter the input beam splitter 24, which passes the infrared light 34 to the infrared detector 28 and reflects the ultraviolet light 36 to the ultraviolet spectrometer 26. The ultraviolet spectrometer 26 converts the amount of absorption of the respective wavelengths of ultraviolet light 36 by the hydrocarbons and nitric oxide to “ultraviolet” electrical signals. The ultraviolet spectrometer 26 sends the ultraviolet signals to the processor 30, which calculates from the ultraviolet signals the amount of hydrocarbons and nitric oxide in the exhaust. The infrared detector 28 sends the infrared signal to the processor 30, which calculates the amount of carbon dioxide and carbon monoxide in the vehicle exhaust.

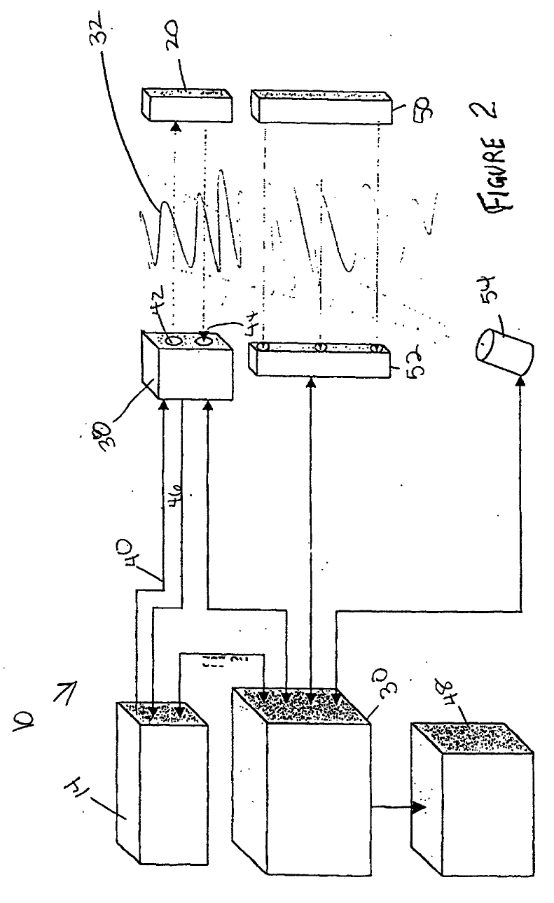

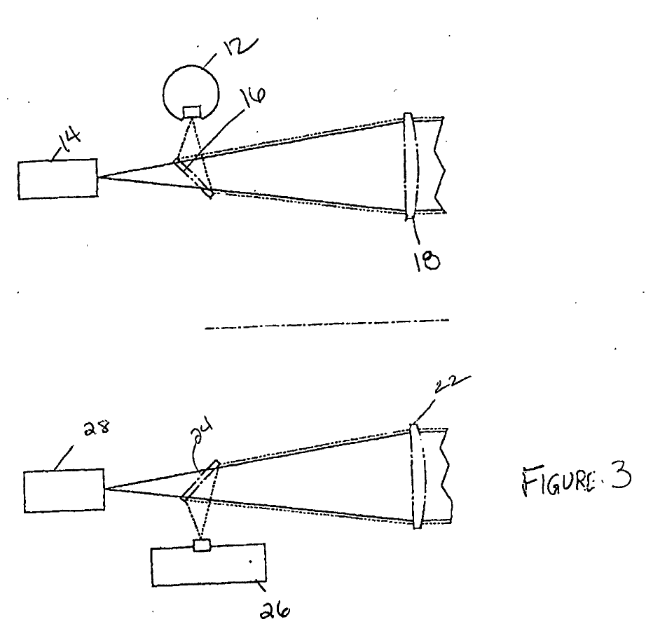

Referring now to FIGS. 2 and 3, the ultraviolet light source 12 is contained within a telescope 38. Preferably, the ultraviolet light source is a broadband high intensity source, such as a deuterium lamp, placed at the focal point of the output lens 18, which thereby collimates the ultraviolet light. The infrared light source 14 is a near-infrared tunable laser diode external to the telescope that sends near-infrared light through a fiber optic cable 40 and into the telescope 38 and emits the light at the focal point of the output lens 18, which thereby collimates the infrared light as well. The output beam splitter 16 passes the infrared light 34 and reflects the ultraviolet light 36 toward the output lens 18, as shown in FIG. 3. Thus, there are two distinct focal points, one for infrared light and one for ultraviolet light. The output lens 18 collimates the infrared 34 and ultraviolet light 36, which propagates out through the top aperture 42 of the telescope 38, and through the plume of vehicle exhaust 32. The collimated light beam encounters the retroreflector 20 and returns to the telescope 38 through the bottom aperture 44.

The telescope 38 also contains the input lens 22, which focuses the collimated light beam to a point. As shown in FIG. 3, the input beam splitter 24 focuses the infrared light beam 34 on the infrared detector 28, and the ultraviolet light beam 36 on the ultraviolet spectrometer 26. Both the detector 28 and spectrometer 26 are located in the telescope 38.

The infrared detector 28 sends an analog signal through coaxial cable 46 to the infrared source 14. This analog signal represents the absorption of the near-infrared light by the exhaust plume 32. The infrared source 14 converts the analog signal to a digital signal and sends the digital signal to the processor 30, which is a computer. Additionally, the ultraviolet spectrometer 26 sends a digital signal to the computer 30 which represents the absorption of the ultraviolet light by the exhaust plume 32. The computer 30 calculates the amount of hydrocarbons and nitric oxide in the vehicle exhaust 32 from the ultraviolet signal and the amount of carbon dioxide and carbon monoxide in the vehicle exhaust 32 from the infrared signal. The monitor 48 displays the calculations.

In order to determine when a vehicle is passing, the infrared detector 28 monitors the infrared beam. When a vehicle passes, the infrared beam is temporarily interrupted and the detector 28 sends a signal to the computer 30 and to the ultraviolet spectrometer 26 to begin calculations. Alternatively, a separate infrared beam 50 may be propagated across the roadway, and a detector 52 can monitor the light beam and send a signal to the computer to begin calculations. A camera 54 is also employed, and is instructed to take a picture of the license plate of a vehicle that emits too many pollutants.

The ultraviolet light source 12 may be any suitable broadband light source such as the aforementioned deuterium lamp. The ultraviolet light source 12 can also be separate from the telescope 38. The infrared light source 14 is tunable across a band of near-infrared wavelengths and delivers the infrared light 34 through a fiber optic cable 40. However, other sources of variable wavelength, narrow line width near-infrared light and ultraviolet light can be used without departing from the principles of the invention. The beam splitters 16 and 24 may be dichroic mirrors. Dichroic mirrors are typically fabricated by multiple layers of dielectric material placed on a transparent substrate so that they reflect light of one or more wavelength regions yet transmit light of other wavelength regions, as is commonly understood in the art. These mirrors are substantially flat and relatively thin and, by appropriate selection of the dielectric layers, can be designed to reflect and transmit the desired wavelengths of light for a given application. However, it is to be recognized that other wavelength-selective devices which are physically compatible with the structure described and claimed herein may be used without departing from the principles of the invention. The processor shown in FIG. 2 may be a general or special purpose computer.

While the remote detecting apparatus of the present invention is particularly adapted for measuring pollutants in vehicle exhaust, it may be used in other applications that require remote sensing of hydrocarbons in a gas.

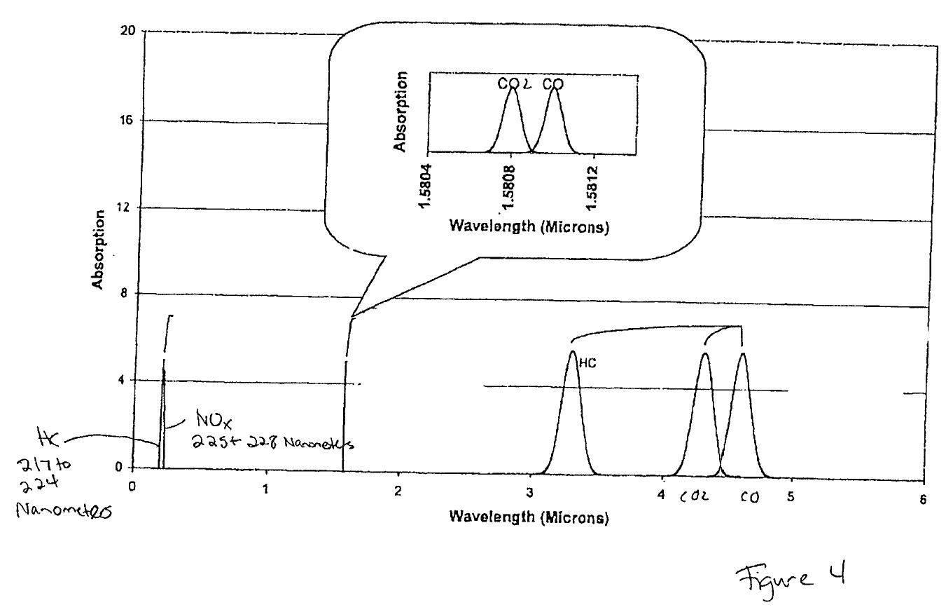

FIG. 4 is a graph of absorption versus wavelength for various pollutants. Hydrocarbons absorb wavelengths of light from about 217 to 224 nanometers, while nitric oxide absorbs wavelengths of light from about 225 to 228 nanometers. The broadband ultraviolet light source preferably used in the present invention covers the range of ultraviolet wavelengths that include the absorption lines for hydrocarbons and nitric oxide, so that the ultraviolet spectrometer 26 produces signals representative of the amount of those compounds. Carbon dioxide absorbs light in the near-infrared range at a wavelength of about 1.5808 microns, and carbon monoxide absorbs light in the near-infrared range at a wavelength of about 1.5810 microns. The variable wavelength tunable laser diode is scanned to the carbon dioxide and carbon monoxide absorption lines to produce a signal representative of the amount of each of those compounds when the laser is tuned to their absorption line.

The terms and expressions which have been employed in the foregoing specification are used therein as terms of description and not of limitation, and there is no intention, in the use of such terms and expressions, of excluding equivalents of the features shown and described or portions thereof it being recognized that the scope of the invention is defined and limited only by the claims which follow.

We claim:

1. An apparatus for remotely sensing the amount of pollutants in the exhaust plume of a vehicle, comprising:
an ultraviolet light source for propagating ultraviolet light through the exhaust plume;
an output lens for collimating the ultraviolet light from the ultraviolet light source before it propagates through the exhaust plume; and
an ultraviolet light spectrometer for receiving said ultraviolet light after it has passed through the exhaust plume of a vehicle and producing a hydrocarbon signal representative of the amount of absorption of the ultraviolet light by selected hydrocarbons in the vehicle exhaust plume.

2. The apparatus of claim 1, further comprising an input lens for receiving the ultraviolet light that has passed through the exhaust plume and focusing the light on said spectrometer.

3. The apparatus of claim 1, wherein said spectrometer also produces a nitric oxide signal representative of the amount of absorption of the ultraviolet light by nitric oxide.

4. The apparatus of claim 3, further comprising an infrared light source for propagating near-infrared light through the exhaust plume, and an infrared detector for receiving said near-infrared light after it has passed through the exhaust plume of a vehicle and producing a near-infrared signal representative of the amount of absorption of near-infrared light by the exhaust plume.

5. The apparatus of claim 4, wherein said infrared light source can produce a wavelength corresponding to an absorption line of carbon dioxide, said near-infrared signal represents the amount of absorption of the near-infrared light by carbon dioxide in the vehicle exhaust plume, and said apparatus further comprises a processor, responsive to said ultraviolet and near-infrared signals, for providing an indication of the amount of said selected hydrocarbons and selected nitric oxide relative to the amount of carbon dioxide in the exhaust plume.

6. The apparatus of claim 4, wherein said infrared light source is tunable across a band of near-infrared wavelengths so as to produce a near-infrared signal representative of the amount of absorption of near-infrared light by carbon dioxide and carbon monoxide in the exhaust plume.

7. The apparatus of claim 6, wherein said processor further determines the amount of carbon monoxide relative to the amount of carbon dioxide in the exhaust plume.

8. The apparatus of claim 1, further comprising an infrared light source for propagating near-infrared light through the exhaust plume, and an infrared detector for receiving said near-infrared light after it has passed through the exhaust plume of a vehicle and producing a near-infrared signal representative of the amount of absorption of near-infrared light by the exhaust plume.

9. The apparatus of claim 8, wherein said infrared light source can produce a wavelength corresponding to an absorption line by carbon dioxide, said near-infrared signal represents the amount of absorption of the near-infrared light by carbon dioxide in the vehicle exhaust plume, and said apparatus further comprises a processor, responsive to said ultraviolet and near-infrared signals, for providing an indication of the amount of said selected hydrocarbons relative to the amount of carbon dioxide in the exhaust plume.

10. The apparatus of claim 9, wherein said infrared light source is tunable across a band of near-infrared wavelengths so as to produce a near-infrared signal representative of the amount of absorption of near-infrared light by carbon dioxide and carbon monoxide in the exhaust plume, said processor being adapted also to determine the amount of carbon monoxide relative to the amount of carbon dioxide in the exhaust plume.

11. The apparatus of claim 1, further comprising a tunable infrared light source for propagating near-infrared light through the exhaust plume, and an infrared detector for receiving said near-infrared light after it has passed through the exhaust plume of a vehicle and producing a near-infrared signal representative of the amount of absorption of near-infrared light by the exhaust plume.

12. The apparatus of claim 11, further comprising a processor for determining from said ultraviolet signal and said near-infrared signal the relative amounts of said selected hydrocarbons and other materials having ultraviolet and near-infrared absorption lines.

13. The apparatus of claim 11, wherein said tunable infrared light source is a laser.

14. An apparatus for remotely sensing the amount of pollutants in a plume of vehicle exhaust, comprising:
an ultraviolet light source for propagating ultraviolet light through the exhaust plume;
a tunable infrared light source for propagating near-infrared light through the exhaust plume;
an ultraviolet light spectrometer for receiving said ultraviolet light after it has passed through the exhaust plume of a vehicle and producing a hydrocarbon signal representative of the amount of absorption of the ultraviolet light by selected hydrocarbons in the vehicle exhaust plume and a nitric oxide signal representative of the amount of absorption of the ultraviolet light by nitric oxide;
an infrared detector for receiving said near-infrared light after it has passed through the exhaust plume of a vehicle and producing a near-infrared signal representative of the amount of absorption of near-infrared light by the exhaust plume; and
a processor, responsive to said ultraviolet signal and said near-infrared signal, for determining the relative amounts of said selected hydrocarbons, selected nitric oxide, and carbon dioxide in the exhaust plume.

15. The apparatus of claim 14, wherein said processor further determines the relative amount of carbon monoxide in the exhaust plume.

16. The apparatus of claim 14, further comprising an output beam splitter disposed so as to receive ultraviolet light from said ultraviolet light source and near-infrared light from said infrared light source so as to combine ultraviolet and near-infrared light therefrom along a single optical output axis, and an output lens disposed on said output axis for collimating the ultraviolet and near-infrared light with respect to said output axis for propagation through the exhaust plume.

17. The apparatus of claim 16 further comprising, an infrared detector, an input lens, and an input beam splitter, said input beam splitter being disposed so as to receive light from said input lens and split said light into an ultraviolet component directed to said ultraviolet spectrometer and a near-infrared component directed to said infrared detector.

18. The apparatus of claim 17, further comprising a retroreflector for receiving light emitted by said apparatus and passed through the exhaust plume, and reflecting said light to said input lens.

19. The apparatus of claim 14, wherein said tunable infrared light source is a laser.

20. A method of remotely sensing the amount of pollutants in the exhaust plume of a vehicle comprising:
propagating a collimated ultraviolet light beam through the exhaust plume; and
determining the intensity of predetermined wavelengths of ultraviolet light corresponding to absorption lines of selected hydrocarbons after said ultraviolet light beam has passed through the exhaust plume, said intensity of said predetermined wavelengths of ultraviolet light corresponding to the amounts of respective selected hydrocarbons in the exhaust plume.

21. The method of claim 20, further comprising determining the intensity of a predetermined wavelength of said ultraviolet light corresponding to an absorption line of nitric oxide after said ultraviolet light has passed through the exhaust plume, said intensity of said wavelength of ultraviolet light corresponding to the amount of nitric oxide in the exhaust plume.

22. The method of claim 20, further comprising propagating a collimated near-infrared light beam through the exhaust plume, and determining the intensity of a predetermined wavelength of said near-infrared light corresponding to an absorption line of carbon dioxide after said near-infrared light has passed through the exhaust plume, said intensity of said predetermined wavelengths of near-infrared light corresponding to the amount of carbon dioxide in the exhaust plume.

23. The method of claim 22, further comprising determining the intensity of a predetermined wavelength of said ultraviolet light corresponding to an absorption line of nitric oxide after said ultraviolet light has passed through the exhaust plume, said intensity of said wavelength of ultraviolet light corresponding to the amount of nitric oxide in the exhaust plume.

24. The method of claim 23, further comprising tuning said near-infrared light beam separately to said absorption line of carbon dioxide and to an absorption line of carbon monoxide, and determining the amounts of said selected hydrocarbons, nitric oxide and carbon monoxide relative to carbon dioxide in the exhaust plume
